(19) United States
(12) Patent Application Publication
(10) Pub. No.: US 2011/0295657 A1
(43) Pub. Date: Dec. 1, 2011

(54) TEST-WEIGHTED VOTING

(76) Inventor: Herman Euwema, Monmouth Jct., NJ (US)

(21) Appl. No.: 12/910,481

(22) Filed: Oct. 22, 2010

Related U.S. Application Data
(60) Provisional application No. 61/254,603, filed on Oct. 23, 2009.

(51) Int. Cl. G07C 13/00

(52) U.S. Cl. 705/12

(57) ABSTRACT

The object of the invention is to provide a method of voting whereby votes are weighted by voters' score on a test. Say officials are not sufficiently science-minded. Votes for officials are weighted with the scores of voters on tests which could be mostly from high school algebra where good grades enable students to go on to science and engineering. This weighted vote reveals the science-quality problem-solving ability, or lack, of candidates, and so more science-minded officials are elected.

### BACKGROUND OF THE INVENTION

This invention relates to bringing Science, Technology, Engineering and Mathematics (STEM) into representative voting. The problem with STEM became acute when President George W. Bush considered in 1903 whether to appoint an Iraqi government that was like himself versus what he called “Technocrats”, meaning unknown since he dismissed that choice. Now seven years later, Iraqi engineering services such as electricity and water are worse than they were under Saddam Husein. The trillions of dollars of war costs has increased USA debt that has brought the USA government to the kind of hopeless blaming gridlock as Iraq, which has no government for over seven months.

Now in 2010 the USA finds that it ranks about twentieth among nations in STEM education and has a perhaps insurmountable fiscal debt to China which has taken over much of its manufacturing and whose governing body are all engineers.

My analysis of the root cause of this is the split in communication and understanding between the small minority of people educated in STEM, and those not, first pointed out by C. P. Snow in his 1959, “Two Cultures”. I think I have found a crucial point in all this, to which this invention is directed, in the fact that high school students who do well in algebra are the most sought after by STEM universities, where four years of continuous STEM problem-solving make them disappear from the culture of others, who are the vast majority of voters.

This situation largely came about because some political strategists thought that the Soviet fall was due to the political attraction of universal suffrage (EqVote) in the USA starting soon before. This led G. W. Bush to invade Iraq in hope of starting a spread of this idea, calling it “democracy” in a mid-east that had watched that name next door for some 2000 years. Only Hamas bought it. But America originally defined democracy with strong restrictions on who could vote. Without any such, EqVote becomes ‘mobocracy’ or ‘mediacracy’ which is how the mid-east viewed it. So the problem instead is if there is any voting mechanism whatever that can make voting more effective for desired goals without being rude to some. It seems that the impoverished third world wants STEM at first more than representative government and the rule of law.

### BRIEF SUMMARY OF THE INVENTION

So I propose that voters get tested in simple high school algebra (which almost everyone in a developed economy can remember, and can remember some classmates disappearing into STEM education), by an easily administered test, and that their scores, kept private, weight their vote. This is necessary not only to radically change American education in STEM but also to make the high school experience, touching STEM, a shared symbol for communication about the need for STEM. Imagine if Bush could have sent Technocrats who told the Iraq or Afghani that the American goal was the quickest way to their self-sustained comfortable technology via high schools combined with a problem-solving government from an algebra test for voters. Doubt and indecision would reign no more.

It would be nice if the government of Iraq knew engineering, as in China, as well as new law, but at least they should be elected by those who can judge whether their thinking is problem-solving rather than feel-good platitudes or hate. We should be able to expect this much from voters without expecting them to be experts in the problems of those they elect. The same will apply to China when they want to enlarge their voting and government participation.

This is an invention in voting for representatives as a social mechanism, especially if STEM issues are involved and algebra can be a test. Ingenuity is needed in the voting mechanism to best achieve goals without injuring the sensibilities of voters.

### DESCRIPTION

The present invention relates to a method of voting whereby votes are weighted by voters' score on a test.

The product is comprised of the following components/entities:
(1) Officials
(2) An election committee (EC)
(3) Eligible voters (EV)
(4) A voter test

Say that the officials are those of a corporate board and all the shareholders are EV. The EC might have been previously chosen by the officials or a referendum of potential voters or represent the choice of some higher authority.

There are three steps in the process:
(1) The step of choosing a test for everyone can be done by the EC and could be a choice of any high school algebra test or a test made mostly of similar questions.
(2) The step of Informing is when the EC serves notice to the, EV where the voter test can be taken and who the candidates will be and when the next voting will occur.
(3) The step of weighted voting consists of a conventional voting by the EV with voters having their vote ,then weighted by some function of their test score, said function, usually proportional, as specified by the EC.

The relation between the steps is succession in the order given.

Presently known computer voting can obviously be extended to Include the computation of the weighted vote for each voter.

Example of another use is in government, where officials might be the president and congress of a developing nation such as Iraq or Afghanistan.

What is claimed is:

1. A method of voting whereby votes are weighted by voters' score on a multiple question test.

2. Claim 1 wherein the test Is of mostly algebra problems.

3. Claim 1 wherein the voters are corporate board members.

4. Claim 1 wherein the voters are citizens of a country.

5. Claim 2 wherein the voters are citizens of a country.
